(19) United States
(12) Patent Application Publication
(10) Pub. No.: US 2008/0257126 A1
(43) Pub. Date: Oct. 23, 2008

(54) Panel sizing circular saw

(75) Inventor: Reinhold BAUER, Ichenhausen (DE)

Correspondence Address: BACON & THOMAS, PLLC, 625 SLATERS LANE, FOURTH FLOOR, ALEXANDRIA, VA, 22314-1176, US

(73) Assignee: Scheppach Fabrikation von Holzbearbeitungsmaschinen GmbH, Ichenhausen (DE)

(21) Appl. No.: 12/078,234

(22) Filed: Mar. 28, 2008

(30) Foreign Application Priority Data
Apr. 17, 2007 (DE) 102007018542.3-15

(51) Int. Cl. B23D 19/00

(52) U.S. Cl. 83/473

(57) ABSTRACT

On a panel sizing circular saw for machining panel shaped material, comprising a machine frame (1) on which provision is made for a stationary table top (2) and, adjacent to the latter, a sliding table (5) which is slidable in a direction parallel to the cutting direction, and further comprising a tilting frame (7) arranged underneath the table, which is tiltable about a tilting axis coplanar with the top surface of the table and extending in cutting direction, on which tilting frame (7) provision is made for a slide (8) which is vertically adjustable by means of a lifting mechanism (11) arranged on the said tilting frame (7), such slide (8) carrying at least one drivable cutting tool (3) extending through an associated slot in the table top (2), ergonomic operability can be achieved in that the lifting mechanism (11) accommodated on the tilting frame (7) associated with the slide (8) is connected via a telescopically adjustable articulated shaft (13) with an intermediate drive (14) arranged in a direction transverse to the cutting direction, and via the latter with an angle drive (16) whose input side cooperates with a hand wheel (9) arranged in the outer area of the longitudinal side wall of the machine associated with the sliding table (5).

### FIELD OF THE INVENTION

This invention relates to a panel sizing circular saw for cutting panel shaped material.

### BACKGROUND OF THE INVENTION

Circular saw benches with arrangements for vertical and angular adjustment of the saw blade are known to the art, in which the controls for such adjustments are arranged in the area of the rear transverse side of the machine frame, as viewed in cutting direction. However, this would prove unfavourable on a circular saw suitable for machining panel shaped material, which has a sliding table arranged adjacent to the regular machine table, because the operator stands on the outside of the guideways carrying the sliding table. For making machine adjustments the operator would in each case have to walk around such sliding table guideways. Especially for vertical adjustments this disadvantage would make itself felt in a particularly noticeable manner, since such vertical adjustments have to be made very frequently. On the other hand, it is not simply feasible to reposition the controls from the rear transverse side of the machine frame to the longitudinal side of the sliding table while leaving the entire remaining component parts of the power transmission system at their original locations.

On these premises it is the object of this invention to provide a panel sizing circular saw suitable for the machining of panel type material, which permits an ergonomic operation of at least the controls for vertical adjustment of the cutting tool.

### SUMMARY OF THE INVENTION

This object is achieved by the combination of features described in Claim 1.

Proposed is a panel sizing circular saw of the type described above comprising a machine frame on which provision is made for a stationary table top and, adjacent to the latter, a sliding table which is slidable in a direction parallel to the cutting direction and which comprises a tilting frame arranged underneath the table which is tiltable about a tilting axis coplanar with the top surface of the table and extending in cutting direction, on which tilting frame provision is made for a slide which is vertically adjustable by means of a lifting mechanism arranged on the said tilting frame, such slide carrying at least one drivable cutting tool extending through an associated slot in the table top, with the lifting mechanism carried by the tilting frame and associated with the slide is connected via a telescopically adjustable articulated shaft with an intermediate drive arranged in a direction transverse to the cutting direction and via the latter with an angle drive whose input side cooperates with a hand wheel arranged in the outer area of the longitudinal side of the machine associated with the sliding table.

The intermediate drive arranged in a direction transverse to the cutting direction, which may expediently be designed as a chain drive, permits in an advantageous manner the provision of a power train of roughly U-shaped configuration, leading from the hand wheel disposed in the area of the sliding table sided longitudinal machine side to the lifting mechanism provided on the tilting frame. The said intermediate drive can in this case expediently be arranged on the inner side of the rear transverse wall of the machine frame, as viewed in cutting direction, so that for the connection with the lifting mechanism a similar articulated shaft arrangement can be used as on known circular saws, which fact facilitates the incorporation of service tested elements and thus simplifies manufacture. Nevertheless such a design permits a user friendly and ergonomically favourable location of the hand wheel for vertical adjustment within the range of the regular position of the operator. The measures described in the foregoing will thus completely eliminate the problems cited initially above.

Advantageous embodiments and expedient further developments of the main claim measures will be evident from the subclaims.

Thus the input of the intermediate drive may expediently be connected with the angle drive receiving the hand wheel via a shaft which is disposed parallel to the sliding table sided longitudinal machine wall and may preferably be designed as an articulated shaft. The wall-parallel articulated shaft permits in an advantageous manner the positioning of the vertical adjustment hand wheel at a comparatively large distance from the rear transverse wall of the machine frame and thus within a user friendly range. At the same time, such a configuration will ensure that, between the above mentioned first hand wheel and the rear transverse machine wall, provision can be made for the hand wheel associated with angular adjustment, a fact which facilitates the linkage of an adjustment screw drivable by such hand wheel to the tilting frame.

Advantageously the tilting frame is arranged for tilting adjustment by means of a linked screw drive comprising an adjusting screw disposed in a direction transverse to the cutting direction and having a degree of freedom for angular adjustment, which adjusting screw extends beyond the machine longitudinal wall associated with the sliding table and on the outside carries the hand wheel for angular adjustment. Such a configuration in an advantageous manner obviates the need for a reversal of the direction of the power transmission between the hand wheel and the tilting frame and thus results in design simplicity. The adjusting screw disposed transverse to the cutting direction may advantageously be arranged in the area of, and supported by, the rear end wall of the machine frame, as viewed in cutting direction, so that the hand wheel for angular adjustment can be mounted directly on this adjustment screw. The measures proposed in the foregoing ensure that the hand wheel for angular adjustment is located in the area of the operator's position and in this way contributes towards greater operator convenience.

A further expedient measure may consist in placing the hand wheel for vertical adjustment and the hand wheel for angular adjustment at the same level side by side, with a certain distance between them, with the angular adjustment hand wheel being placed at a point towards the rear transverse side of the machine frame, as viewed in cutting direction, and the vertical adjustment hand wheel at a point further away therefrom. This results in a particularly sensible arrangement of these controls.

Further advantageous embodiments and expedient developments of the main claim measures are described in the remaining subclaims and will be evident from the following description of an example in conjunction with the accompanying drawings, wherein

### BRIEF DESCRIPTION OF THE PREFERRED EMBODIMENTS

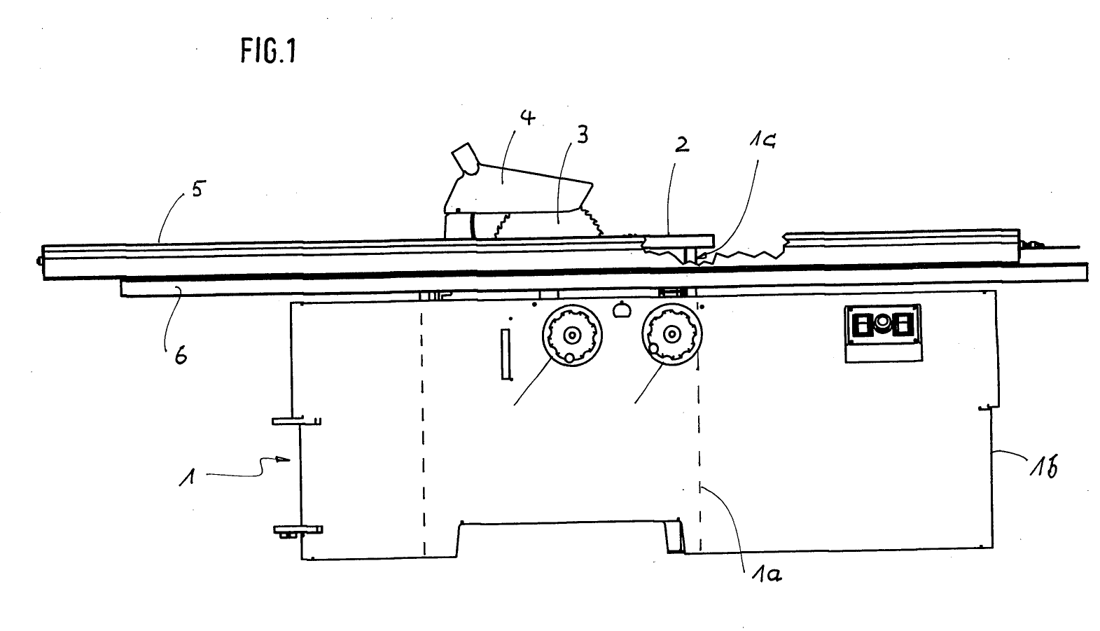

FIG. 1 is a side view of a panel sizing circular saw according to the invention;

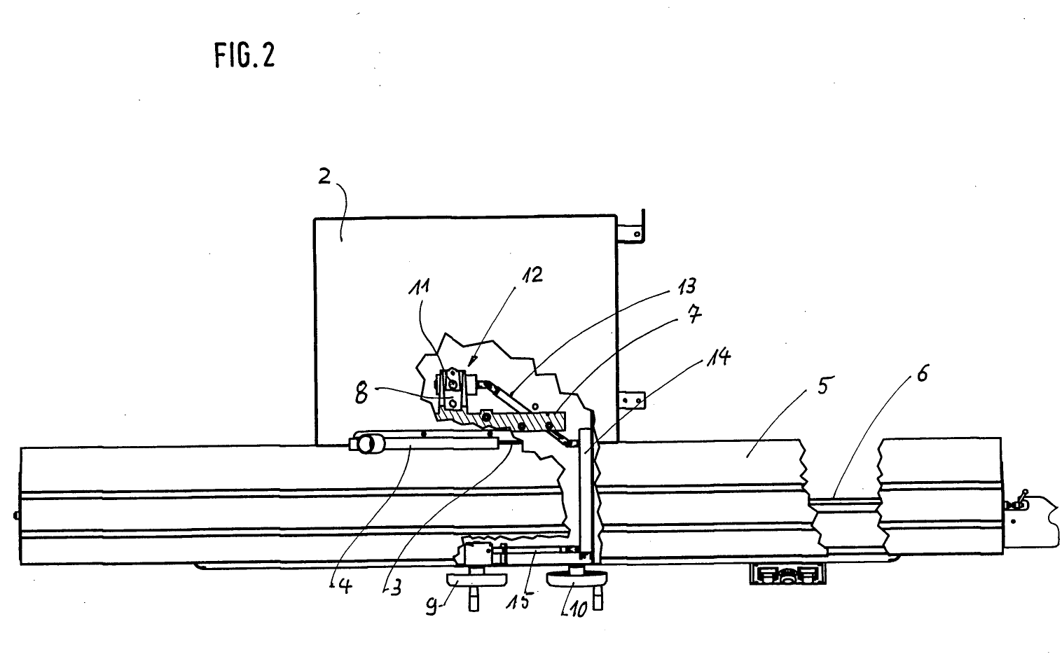

FIG. 2 is a plan view of the arrangement shown in FIG. 1 with a broken-out section in the area of the vertical adjustment mechanism;

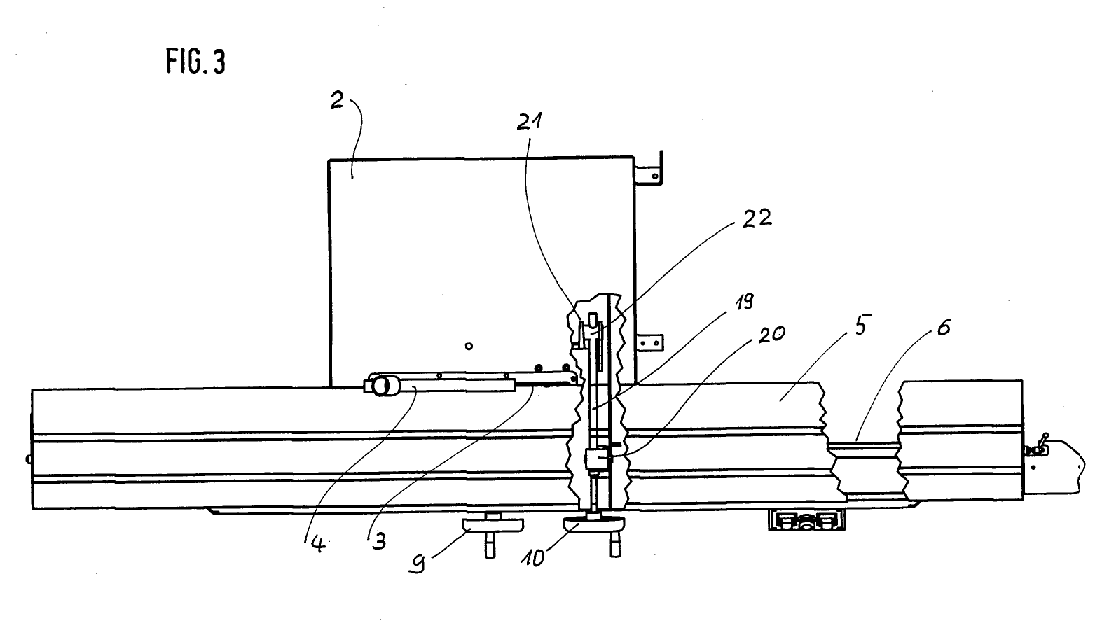

FIG. 3 is a plan view of the arrangement shown in FIG. 1 with a broken-out section in the area of the angular adjustment mechanism;

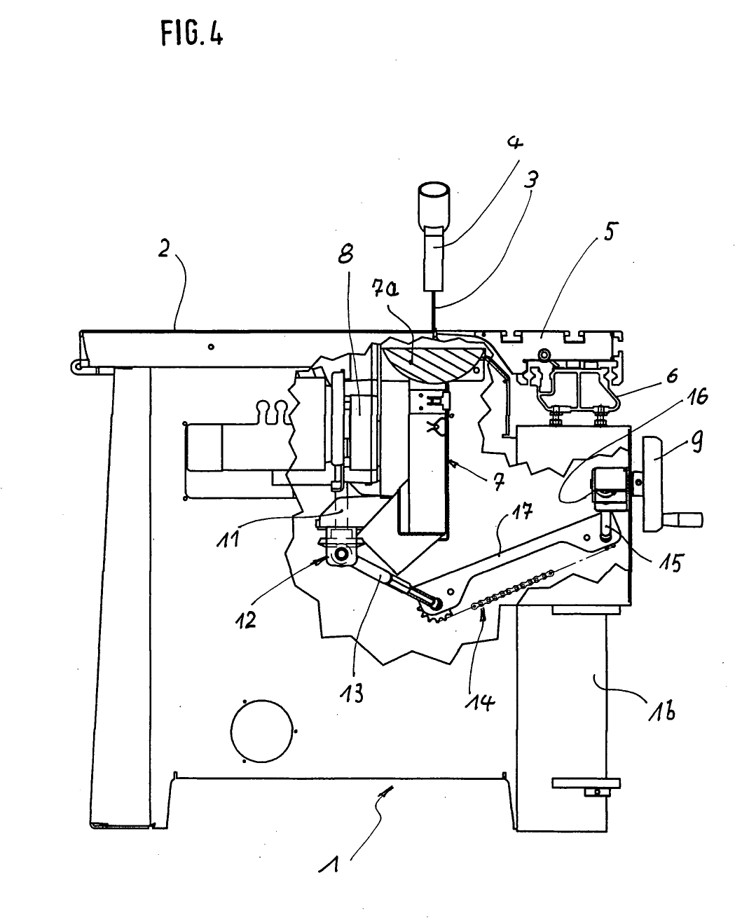

FIG. 4 is a front view of the arrangement shown in FIG. 1 with a broken-out section in the area of the vertical adjustment mechanism;

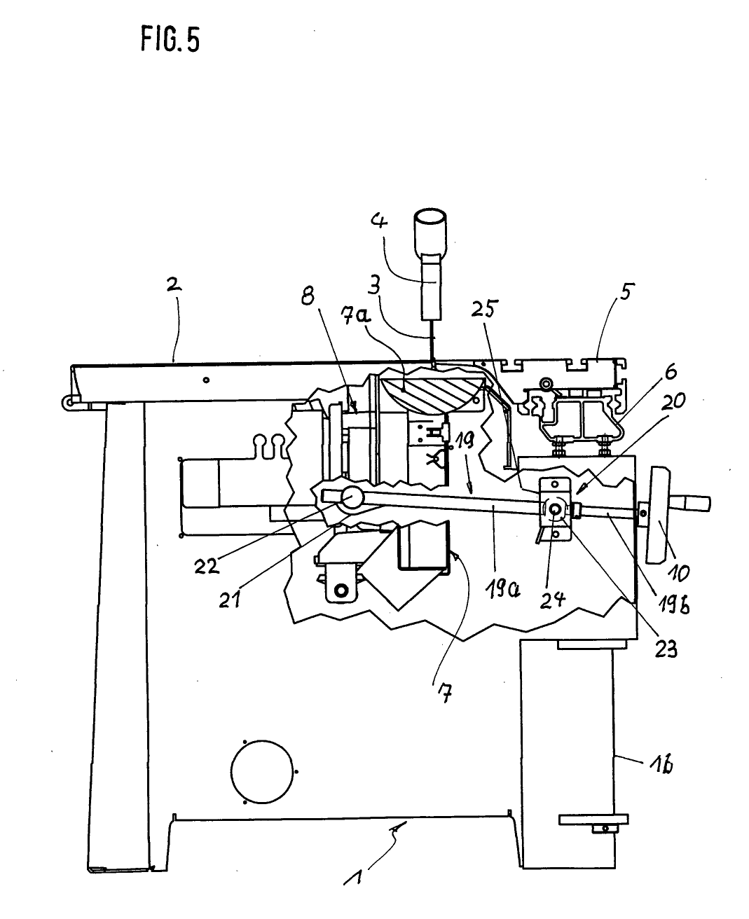

FIG. 5 is a front view of the arrangement shown in FIG. 1 with a broken-out section in the area of the angular adjustment mechanism.

### DESCRIPTION OF PREFERRED EMBODIMENTS

The main field of application of the present invention is the realm of so-called panel sizing circular saws suitable for cutting large size workpieces, such as large panels and the like.

The panel sizing circular saw shown in FIG. 1 comprises a machine frame 1 with a stationary table top 2 mounted thereon through which latter a cutting tool, in this case designed as a saw blade 3, extends. Associated with this saw blade 3 is a guard 4, here designed as an exhaust hood. Adjacent to the said table top 2 provision is made for a sliding table 5 which is slidable in cutting direction. This sliding table 5 is slidably mounted on a longitudinal guideway arrangement 6 projecting forward and to the rear beyond the stationary table top 2. The said longitudinal guideway arrangement 6 is mounted on the machine frame 1 which is for this purpose provided with an attached section 1b projecting beyond the table top 2, and the associated subframe 1a, respectively, in a forward and rearward direction.

The saw blade 3 is vertically adjustable for the purpose of adaptation thereof to different workpiece thicknesses. In addition, the saw blade 3 can be tilted about a desired angle relative to a plane perpendicular to the table surface, for example for taking mitre cuts. For this purpose, as can best been seen from FIGS. 4 and 5, the tool—in this case a saw blade—is associated with a tilting frame 7 arranged underneath the table top 2, which is arranged for tilting about an axis parallel to the cutting direction and in alignment with the surface of the table top 2 and to which a vertically adjustable slide is attached which carries the tool together with its drive system.

For effecting vertical adjustment and angular adjustment, as can be seen from FIG. 1, the example shown comprises two hand wheels 9 and 10, respectively, which are arranged in the area of the outside of the sliding table sided longitudinal side of the machine frame 1, that is to say of the longitudinal side on the frame attachment 1b accommodating the guideways 6, and which are thus conveniently accessible for a person operating the sliding table 5. In the example shown, the two hand wheels 9, 10 are provided side by side, with a certain distance between them, in the area of the sliding table sided external side of the machine frame. It is of particular importance that especially the hand wheel 9 for vertical adjustment is arranged in the area of the sliding table sided external side of the machine frame, since vertical adjustments have to be made very frequently. The hand wheels 9, 10 are arranged in such a way that the hand wheel 9 for vertical adjustment is positioned in front, as viewed in cutting direction, relative to the hand wheel 10 for angular adjustment and is thus associated with the left hand of an operator standing adjacent to the sliding table 5, or its guideways 6, respectively, and facing the cutting tool.

For lifting and lowering the slide 8 accommodating the tool, such slide 8, as can best been seen from the FIGS. 2 and 4, is in engagement with a lifting mechanism 11 mounted on the tilting frame 7. In the example shown, the lifting mechanism is designed as an upright adjusting screw which engages a nut provided on the side of the slide. At its lower end, the adjusting screw forming the lifting mechanism 11 is connected with an angle drive 12. From the latter, a roughly U-shaped power train leads to the hand wheel 9. This power train comprises a telescopically adjustable articulated shaft 13 connected with the input side of the angle drive 12 and, at the end away from the angle drive 12, with the output side of an intermediate drive 14 disposed in a direction transverse to the cutting direction. The ends of the articulated shaft 13 are connected via cardan joints with the input side of the angle drive 12 and the output side of the intermediate drive 14. The latter is expediently mounted on the inside of the rear wall 1c, as viewed in cutting direction, of the subframe 1a of the machine frame 1 carrying the table top 2 and/or a transverse wall in alignment therewith of the attachment 1b of the machine frame 1 associated with the guideways 6. The intermediate drive 14 extends up to the area of the inside of the sliding table sided lateral wall of the machine frame 1, that is to say the attachment 1b thereto.

A shaft 15 arranged approximately parallel to the said lateral wall extends from the input end of the intermediate drive 14 to an angle drive 16 attached to the said lateral wall, which on the input side is fitted with a shaft stub extending through the said lateral wall and carrying the hand wheel 9. The shaft 15 is expediently likewise designed as an articulated shaft whose ends are connected with their associated counterpart elements via cardan joints. This ensures that the input side of the intermediate drive 14 can be located at a lower level than the angle drive 16 and, as a result, the hand wheel 9 attached to it, which latter is supposed to be located at the normal operating height.

The intermediate drive 14 may be designed as a gearing. In the example shown the intermediate drive 14 is designed as a chain drive comprising a rotary transmission element running on two sprockets, which ensures the accurate transmission of the rotational movement and in a simple manner permits the bridging of a relatively large distance. The chain drive constituting the intermediate drive 14 is carried by an associated support bracket 17 which may be attached to the inside of the rear transverse wall, as viewed in cutting direction, of the subframe associated with the table top 2 of the machine frame 1 and with its input-side end portion extends into the frame attachment accommodating the guideways 6, or may be attached to an intermediate wall of such frame attachment. In the example shown the support bracket 17 is advantageously designed as a cover or chain guard, respectively.

For the purpose of angular adjustment, that is to say for tilting the cutting tool 3 relative to a plane perpendicular to the table top surface, the tilting frame 7, which is pivotally attached to the underside of the table top 2 by means of the tilting bearing 7a, is arranged for tilting about its tilting axis by means of a screw drive linked to it, as can be seen from FIGS. 3 and 5. The said screw drive comprises a screw 19 extending in a direction transverse to the cutting direction, and thus transverse to the tilting axis, and has a degree of freedom for angular adjustment. This screw 19 is rotatably held and axially supported by an axial bearing 20 which is pivotally attached to the machine frame. The portion of the screw 19 which extends towards the tilting frame 7 is provided with a threaded section 19a which engages a nut 22 arranged pivotally in a fork 21 of the tilting frame 7. The other end portion 19b of the screw 19, which stands out beyond the axial bearing 20, extends through an associated opening in the sliding table sided lateral wall of the machine housing 1, and its end projecting beyond such lateral wall directly engages the hand wheel 10 affixed to it. For performing an angular adjustment, the screw 19, when the hand wheel 10 is operated, carries out a certain angular movement, which is likewise carried out by the hand wheel 10 directly attached to the screw 19. To avoid collisions, the hand wheel 10 is arranged at such a distance from the sliding table sided lateral wall of the housing, that the said angular movement is possible, as can be seen from FIG. 5. In the same manner, a sufficient amount of clearance is provided between the section 19b of the screw 19 and the associated opening in the said lateral wall.

The screw 19 is disposed parallel, and in close proximity, to the rear wall (as viewed in cutting direction) of the machine housing 1. Accordingly, the hand wheel 10, as can be seen from FIGS. 2 and 3, is located in the area of the plane of this wall and can via the axial bearing 20 be accommodated thereon or on a coplanar partition wall of the housing attachment accommodating the guideways 6. The aforesaid arrangement of the hand wheel 10 in the area of the plane of the rear wall of the housing enables the screw 19 between the hand wheel 10 and the tilting frame 7 to be arranged as a one-piece unit in close proximity of the wall, so that an angled power train is dispensable. This is facilitated by the U-shaped power train associated with the hand wheel 9 which permits the desired distance of the hand wheel 9 from the hand wheel 10.

The axial bearing 20 contains a bearing element 23 through which the screw 19 extends, abutting thereon with one shoulder. The said bearing element 23 is provided with lateral extensions 24 with which it is pivotally supported by an associated bracket 25 attached to the housing.

In the example shown, provision is made for separate hand wheels 9 and 10 of their own for each of the two power trains serving for vertical and angular adjustment, respectively. It would, however, also be conceivable to provide only a single hand wheel which, by way of axial adjustment thereof, could be alternatively engageable with one or the other of the two power trains.

What is claimed is:

1. A panel sizing circular saw for machining panel shaped material, comprising a machine frame on which provision is made for a stationary table top and, adjacent to the latter, a sliding table which is slidable in a direction parallel to the cutting direction, and further comprising a tilting frame arranged underneath the table, which is tiltable about a tilting axis coplanar with the top surface of the table, and extending in cutting direction, on which tilting frame provision is made for a slide which is vertically adjustable by means of a lifting mechanism arranged on the said tilting frame, such slide carrying at least one drivable cutting tool extending through an associated slot in the table top, with the lifting mechanism carried by the tilting frame and associated with the slide being connected via a telescopically adjustable articulated shaft with an intermediate drive arranged in a direction transverse to the cutting direction and via the latter with an angle drive whose input side cooperates with a hand wheel arranged in the outer area of the longitudinal side wall of the machine associated with the sliding table.

2. A panel sizing circular saw as claimed in claim 1, whereby the intermediate drive is designed as a chain drive.

3. A panel sizing circular saw as claimed in claim 1, whereby the intermediate drive is arranged on the inside of rear transverse wall of the machine, as viewed in cutting direction.

4. A panel sizing circular saw as claimed in claim 1, whereby the input side of the intermediate drive is connected with the angle drive associated with the hand wheel via a shaft which is preferably also designed as an articulated shaft and extends parallel to the sliding table side machine longitudinal wall, which angle drive is attached to the sliding table sided longitudinal wall of the machine and whose input extends through such wall and on the outside carries the said hand wheel.

5. A panel sizing circular saw as claimed in claim 1, whereby the intermediate drive is accommodated on a support bracket.

6. A panel sizing circular saw as claimed in claim 1, whereby provision is made for a guard associated with the intermediate drive, which overlappingly covers at least the upper side thereof.

7. A panel sizing circular saw as claimed in claim 1, whereby the lifting mechanism is designed as an upright threaded screw which is connected with the articulated shaft via an angle drive attached to the tilting frame.

8. A panel sizing circular saw as claimed in claim 1, whereby the tilting frame is tiltable by means of a thread drive linked to it which comprises an adjusting screw extending in a direction transverse to the cutting direction and having a degree of freedom for angular movement, which adjusting screw extends through the machine longitudinal wall associated with the sliding table and on the outside carries a hand wheel 10 attached to it.

9. A panel sizing circular saw as claimed in claim 8, whereby the adjusting screw on one side, with a threaded portion thereof, engages a nut pivotally attached to the tilting frame, and is on the other side supported by an axial bearing pivotally attached to the machine frame.

10. A panel sizing circular saw as claimed in claim 9, whereby the adjusting screw extends through the axial bearing and that the end portion thereof which stands out beyond such axial bearing extends through an associated opening of the sliding table sided longitudinal machine wall with an adequate amount of clearance and at its outer end carries the associated hand wheel which has a degree of freedom for angular movement relative to the sliding table sided longitudinal machine wall.

11. A panel sizing circular saw as claimed in claim 10, whereby the axial bearing comprises a bearing element provided with lateral extensions which is pivotally accommodated in a bearing bracket attached to the rear transverse wall of the machine, as viewed in cutting direction, on which bearing element the adjusting screw, which is rotatably held therein, axially abuts with one shoulder thereof.

12. A panel sizing circular saw as claimed in claim 8, whereby the adjusting screw is arranged parallel, and in close proximity, to the rear transverse machine wall, as viewed in cutting direction.

13. A panel sizing circular saw as claimed in claim 1, whereby the hand wheels are arranged at the same height level and at a certain distance from each other, with the hand wheel for angular adjustment being disposed at a point toward the rear transverse machine wall, as viewed in cutting direction, and the hand wheel for vertical adjustment at a point further away therefrom.
